(19) United States
(12) Patent Application Publication
(10) Pub. No.: US 2012/0272152 A1
(43) Pub. Date: Oct. 25, 2012

(54) METHOD FOR ADDING A VOICE CONTENT TO A VIDEO CONTENT AND DEVICE IMPLEMENTING THE METHOD

(75) Inventors: Louis Chevallier, La Meziere (FR); Lionel Oisel, La Nouaye (FR)

(73) Assignee: THOMSON LICENSING, Issy-les-Moulineaux (FR)

(21) Appl. No.: 13/501,812

(22) PCT Filed: Aug. 31, 2010
(86) PCT No.: PCT/EP10/62766

§ 371 Date: Jul. 2, 2012

(30) Foreign Application Priority Data
Oct. 15, 2009 (FR) 0904952

(51) Int. Cl. G06F 3/048

(52) U.S. Cl. 715/719

(57) ABSTRACT

The invention relates to a method for adding a voice content to an audiovisual document. Initially, a video document is received in a device for reproducing and recording sound signals. The video content received possesses degraded areas and at least one non-degraded area perfectly visible to a user during the reproduction of said document. Said user reads a text which is recorded in the device. The text is read at determined moments of the reproduction of the video content received by using visual elements appearing in the non-degraded areas. A complete video document is generated by assembling the audiovisual document and at least one newly created sound content.

The present invention relates to a method for adding a new sound content to a video document subject to security constraints and a device implementing the method.

Numerous forms of piracy of audiovisual documents exist nowadays. Cameras installed in cinemas make it possible to produce illicit copies of the projected document. Illegal copies are then found available on networks, or on sale on media such as CDs or DVDs. These copies cause harm to the cinematographic industry and loss of earnings for producers of audiovisual documents. Sophisticated techniques are devised for preventing or detecting such acts. For example, the producer incorporates into the images of the document to be projected a marking that is undetectable to the human eye but perceptible to an apparatus. The marking is rendered visible during the reproduction of the document, thereby considerably degrading the document and greatly limiting its value.

To avoid illicit copying, it is important to make transmission of the document secure before its launch. Generally, the release of a document is effected through trailers which presents it in the form of a short video, generally of 3 minutes. If illegal copies are in circulation before the official release and can be reproduced by a large number of users, this can limit the number of viewers of the document upon its release and considerably decrease its takings. It is therefore important to avoid leaks of all or part of the document before its release. Generally, video and audio tracks are circulated in a secure van.

In the past, certain leaks have occurred during dubbing. When the video and audio contents are finalized, the video track at least is dispatched to dubbers together with the script of the text to be read in the dubbing language. These copies are those of the document which will shortly be released, they therefore have a high value even if the sound track is not associated therewith. Therefore, it is important to secure the transmission of the video track between the producer and the dubbing studio, or to limit the value of this video track. One means consists in using secure transport but this proves expensive if the dubbing is performed by dubbers in the country where this language is spoken.

The present invention makes it possible to limit the value of the document transmitted to the dubbing studio.

The invention relates to a method for adding a new voice content to an audiovisual document, comprising a step of receiving a video document composed of images in a reproduction device; characterized in that certain images of the video document received possess at least one degraded area and at least one non-degraded area, the method furthermore comprising the following steps:
during the reproduction of the video document, acquisition of at least one voice content at a moment defined by a time marker, said time marker defining a zone of the video document whose images contain visual elements appearing in at least one non-degraded area,
transmission to a manager of audiovisual documents of the at least one newly acquired voice content and of the associated time marker,
assembly of the audiovisual document and of at least one newly acquired sound content in such a way that the voice content is reproduced at the moment defined by the associated time marker.

In this way, the document transmitted so as to add new sound contents does not have much cinematographic value.

According to a first refinement, a text representing the speech of the new voice content and a plurality of time markers associated with the text are transmitted to the video document reproduction apparatus. At least one part of said text is reproduced at the indicated moment of the reproduction of the video document with the aid of said time markers. In this way, the dubber can read on the screen the text that he has to articulate. According to a refinement of the first refinement, attributes associated with the text are also transmitted and display at the indicated moment of the reproduction of the video document with the aid of said time markers. These attributes provide the dubber with indications regarding the way to read the text.

According to another refinement of the first refinement, the text is displayed in at least one graphical window of the screen in front of the dubber in a degraded area of the images of the video document. In this way, the whole of the non-degraded part of the document is perfectly readable and usable for dubbing. According to another refinement of the last refinement, the degraded areas of the images of the video document are detected at the document reproduction level. In this way, there is no need to transmit the coordinates of the degraded areas. According to a variant, the positions of the degraded parts of the video document are transmitted and used by the reproduction apparatus to position the graphical window displaying the text in these degraded areas. In this way, there is no need to determine these areas and to consume calculation power in order to analyze the image to be displayed on the screen.

According to another refinement, an audio content constituting the original sound track of the audiovisual document is transmitted to the reproduction apparatus, this audio content being reproduced also during the reproduction of the video content.

The invention also relates to a viewing device comprising a means for receiving a video document arising from the audiovisual document, a means for acquiring and recording voice contents; characterized in that certain images of the video document received possess at least one degraded area and at least one non-degraded area, the acquisition device effecting the acquisition of at least one voice content at a moment defined by a time marker, said time marker defining a zone of the video document whose images contain visual elements displayed by a display means during the reproduction of the video document, the visual elements appearing in at least one non-degraded area, a means for transmitting at least one newly acquired voice content and the associated time marker.

Other characteristics and advantages of the invention will be apparent through the description of a nonlimiting exemplary embodiment of the invention, explained with the aid of the appended figures, among which:

FIG. 1 is an exemplary block diagram of an audio and/or visual content production apparatus,

FIG. 2 represents a block diagram of a dubbing studio according to an exemplary embodiment of the invention,

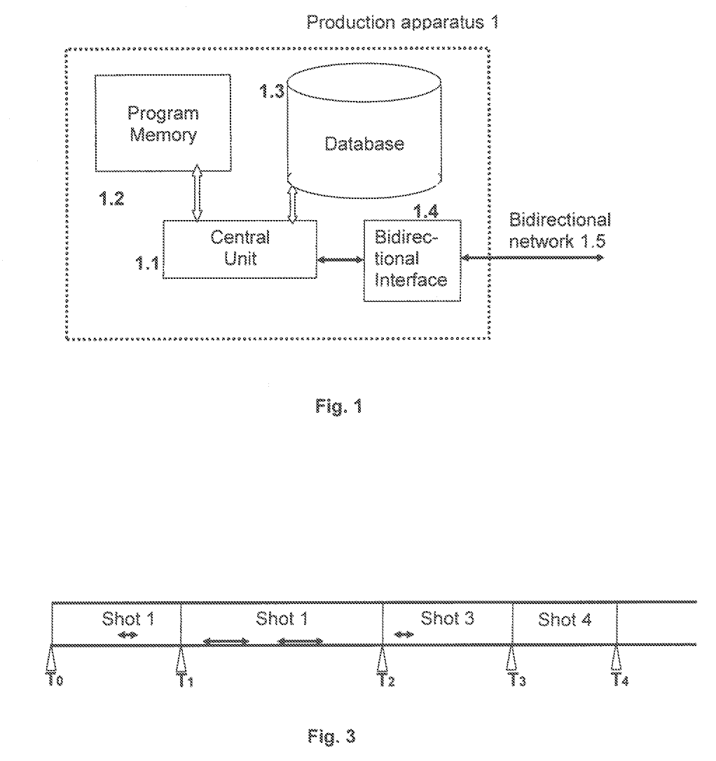

FIG. 3 represents an exemplary layout of the main circuits of the secure area according to an exemplary implementation of the invention,

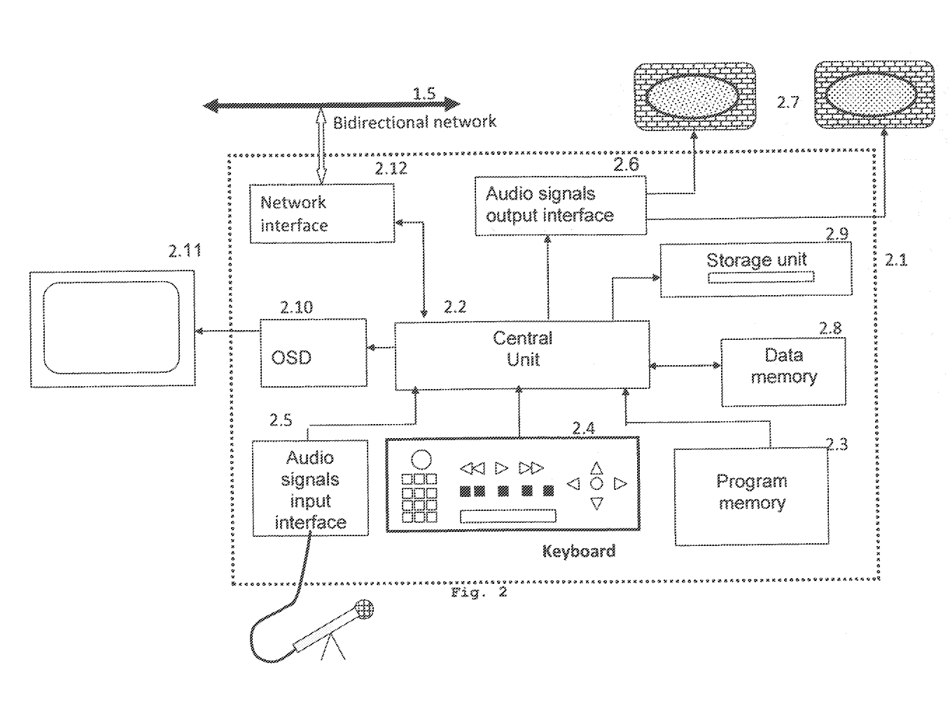

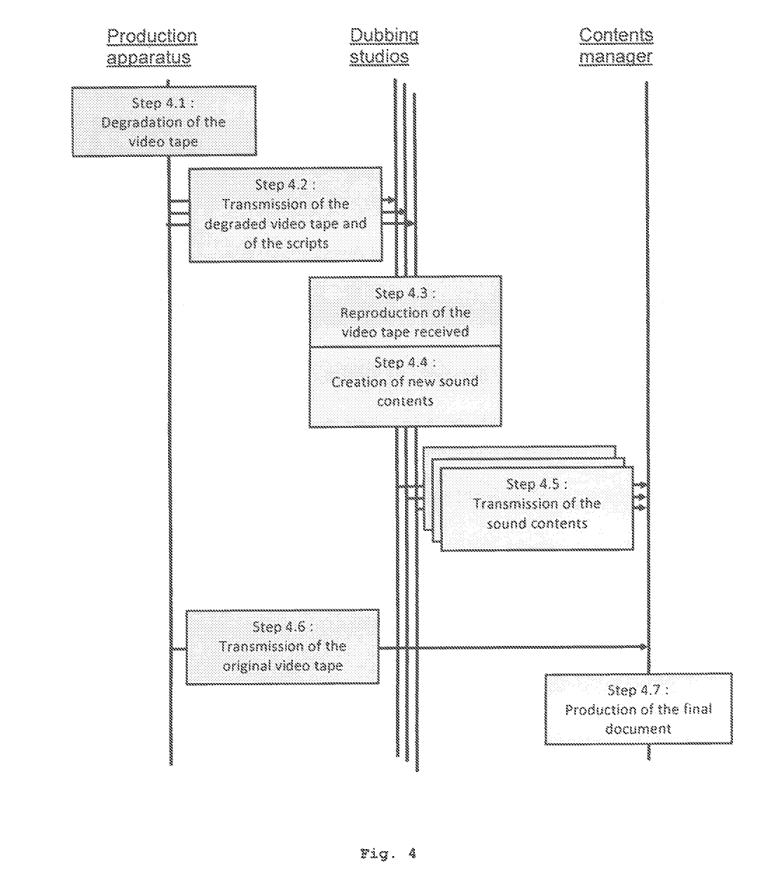

FIG. 4 represents an exemplary screen shot displayed at the dubbing studio level during the creation of new sound tracks,

FIG. 5.a represents an exemplary image of the non-degraded original video track containing a person's face,

FIG. 5.b represents an exemplary image of the degraded video track,

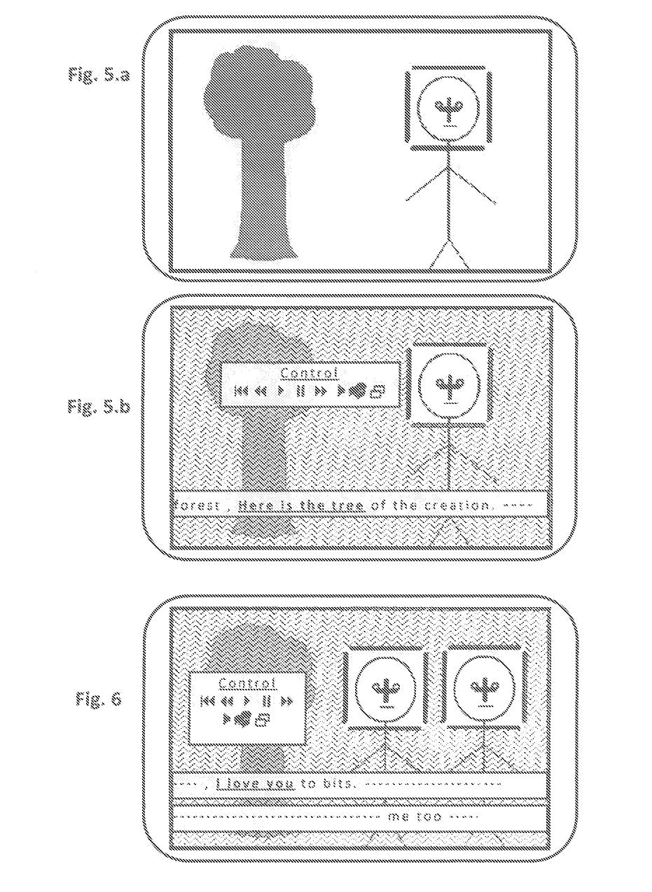

FIG. 6 represents an exemplary image of the degraded original video track containing the faces of two people.

FIG. 1 illustrates a basic layout of a production apparatus for audiovisual documents according to a preferred exemplary embodiment of the invention. The production apparatus 1 comprises a central unit 1.1, a program memory 1.2 comprising an operating program, a database 1.3 containing audio and/or visual contents and a bidirectional communication interface 1.4 making it possible to download and to transmit audio and/or visual contents via a network 1.5. The network 1.5 may be of Internet type.

The program memory 1.2 contains a module for producing an audiovisual document on the basis of various shots (or “cuts”), a module for analyzing the documents stored in the database 1.3, as well as at least one blurring module intended to degrade the image at certain places. The analysis module relies on the possible presence of attributes allowing easier determination on the one hand of the existence of certain characteristics of the image, typically the head of the actors, their faces or their lips, and on the other hand, of the location in the image of said characteristics. Generally, the analysis module determines all the areas of the image which are useful for the dubbing, this may be for example a movement of hands, a light, the sudden appearance of an object, etc.

FIG. 2 illustrates a basic layout of a dubbing studio 2.1. The dubbing studio has a Central Unit 2.2 (UC) linked to a program memory 2.3, a keyboard 2.4 allowing the user to enter all the commands required during the reproduction of the video track and the dubbing, an audio input interface 2.5 allowing the acquisition of the signals coming from a microphone and enabling them to be digitized, an output interface for the audio signals 2.6 comprising at least one amplifier dispatching the amplified sound signals to at least two loudspeakers 2.7. The keyboard 2.4 has a validation key and a rotary element making it possible to displace an index on a screen, this element is for example a mouse linked to the keyboard. The keyboard has keys making it possible to enter the same commands as those accessible by selecting screen icons. The loudspeakers 2.7 are connected to the reader, they may be earphones on a headset worn by the user. A data memory 2.8 is linked to the central unit, this memory, which is typically a hard disk, makes it possible to record audio and/or visual contents. Optionally, the dubbing studio 2.1 has an optionally removable audio and/or visual data storage unit 2.9 capable of reading and of writing on a recording medium such as an audio CD, DVD, magnetic cartridge, electronic card, USB key, etc.

The dubbing studio 2.1 also comprises a circuit 2.10 for displaying data on a remote screen 2.11. This circuit 2.10, often called an OSD circuit, the initials standing for “On Screen Display”, is a text and graphics generator which enables menus, pictograms or other graphics, and menus facilitating dubbing to be displayed on the screen. The OSD circuit is controlled by the Central Unit 2.2 and the program contained in the memory 2.3. The executable program is advantageously realized in the form of a program module recorded in the read-only memory 2.3. It can also be realized in the form of a specialized circuit of ASIC type for example.

The digital bus 1.5 is connected to a network interface circuit 2.12 which transmits audio contents to the dubbing studio 2.1, either in digital form or in analog form, the receiver recording them in the memory 2.8. Audio and/or video content downloading is a well known technique that it is unnecessary to explain in the present application.

The production of an audiovisual document consists in assembling shots (or “cuts”) by abutting them. FIG. 3 illustrates an audiovisual document comprising a plurality of shots. The final document is referenced by time markers, the document begins at the time marker value 0. Each of the shots is referenced with respect to the start of the document, the first shot begins at the time marker value T0, the second shot begins at the time marker value T1, the third at the time marker value T2, etc. In this way, when navigating from shot to shot, the navigation program uses a table of the time markers to point to the new shot. For each shot, one or more time zones contain speech to be translated into another language. These zones, represented by horizontal arrows in FIG. 3, are also indexed by time markers. In this way, during the reproduction of the document, it is possible to navigate from shot to shot, and to display on a timechart the position of the speech zones.

Each event of the document can thus be referenced from the time standpoint. Notably, when speech is spoken by an actor, the start and the end of each sentence is referenced within the document. It is thus perfectly possible to locate the parts of the video track of the document which requires dubbing into another language. Each part is associated with a start time reference and an end time reference.

After having described the various elements, we shall now explain how the latter cooperate.

FIG. 4 illustrates the progress of the various steps between the producer of the audiovisual document, the various dubbing studios and the contents manager. The contents manager may be the producer of the document, the contents manager is responsible for providing the final document together with the dubbings.

At the outset, the production apparatus has the original document composed of the assembly of the diverse sequences and extracts the video component of the document. In step 4.1, the video track of the document is analyzed by a program module so as to determine the various areas where there are elements useful for the dubbing such as the movement of the lips. Next, a second module degrades in each image the part which does not comprise these characteristics. The degradation consists in altering the visual content while, however, preserving the vision of the movements and the perception of the colors. For example, if the video shows a flag flapping in the wind, the viewer can recognize that it is a flag but is unable to determine which one. Numerous video degradation techniques are known, such as blurring, pixellation or even the overlaying of hatching. It is advisable to use a non-reversible technique, calling for example upon a datum that varies randomly throughout the processing of the document.

Following which, the production apparatus has a video document having the same duration, the same time markers but with a degraded image which has little value from the cinematographic standpoint. The production apparatus transmits the degraded video track together with the various scripts corresponding to the dubbing to be performed into various languages (step 4.2). Optionally, an original sound track is also transmitted. According to a first refinement, this sound track is that of the non-speech background noise. In this way, the dubber can synchronize his voice with certain noises. According to a second refinement optionally combinable with the first, the original sound track together with the speech is also transmitted. In this way the dubber can listen to it in order to follow the same voice intonations as those of the actor present in the video track.

A script is a text where each word or group of words is associated with a certain moment of the video document, with the aid of a time marker. The script is transmitted in ASS format, each character is coded in A.S.C.I.I. The syntax of the ASS format makes it possible to specify time markers. According to one refinement, the script is transmitted in an encrypted manner, the code allowing decryption is given to the dubber by another means of transport.

Each dubbing studio receives the degraded video document and the script corresponding to its language. In step 4.3, the dubber launches the reproduction of the degraded video track, on the menu of the screen facing him, the script is displayed while indicating by a marker at the moment of reading. If the script is received encrypted, the dubber must enter the decryption code before launching the reproduction of the document. While looking at the images of the face appearing on the screen of the actor that he is dubbing and by reading the script which is displayed at another place, the dubber articulates his text into the microphone of the dubbing studio. The dubber uses the movement of the actor's lips to achieve a better match with his text (step 4.4). Commands are available allowing the dubber to hear himself back, to recommence a recording and to validate the recording that he has just made. A new voice content is thus created, this voice content is synchronized with the same time markers as those of the degraded video document.

In step 4.5, the various dubbing studios transmit the new voice contents to the contents manager, together with the associated time markers. According to a preferred embodiment, the voice contents as well as the associated time markers are transmitted to the contents manager in an encrypted manner. At the same time, the production apparatus (if it is different from the contents manager) transmits the original (non-degraded) video track to the contents manager (step 4.6). In step 4.7, the contents manager produces the final document. Accordingly, the manager produces as many audio tracks as there are languages by mixing the voice contents of the dubbers with the background noise. Assembly of the various sound sequences articulated by the dubbers is performed at the moment specified by the time markers. Ultimately, the audiovisual document comprises a video track and as many sound tracks as there are languages.

FIGS. 5.a and 5.b illustrate screen shots displaying images of the document at diverse moments of the processing.

FIG. 5.a represents an exemplary image of the non-degraded original video track containing a face such as it may be displayed at the production apparatus 1 level. Before being transmitted to the dubbing studio 2.1, this image will be degraded with the exception of the areas displaying faces.

FIG. 5.b represents an exemplary menu displayed by a dubbing studio 2.1. The image displayed is that represented in FIG. 5.a after degradation. It is seen that the whole of the image is blurred with the exception of the single individual's face.

The script to be read by the dubber appears on a scrolling banner at the bottom of the image. A graphical cursor moves over the text to indicate approximately the word or the part of words that the dubber must read at the moment corresponding to the image displayed. The graphical cursor is moved by using the time markers of the script, it covers approximately two seconds of speech. The graphical cursor may be a change of color of the text, underlining, character emboldening, etc. The dubber must observe the movement of the actor's lips on the image displayed so that the movement of the lips corresponds best to the sentences read. Above all, he must contrive to speak at the moment the actor's lips are moving. This is why it is important that the actors' faces are not degraded and appear on the screen with good definition. Let us assume for example that the film “Quai des brumes” is being dubbed, and that the actor Jean Gabin is articulating in French “t'as d'beaux yeux, tu sais”. This sentence written in another language may invert the words, as “Tu sais que tu as de beaux yeux”. The dubber must therefore articulate his sentence within the time delimited by the movement of the lips, and not make the words of the original language match the words of the dubbing language at exactly the same moment.

Advantageously, a command menu is displayed on the screen allowing the dubber to recall the commands available. These commands are:
Play ( [symbol] )
Play with the original sound ( [symbol] , if available)
Play with the background noise ( [symbol] , if available)
Return to the start of the shot ( [symbol] )
Skip to the next shot ( [symbol] )
Skip to the previous shot ( [symbol] )
Record the articulated sequence ( [symbol] )

These commands are accessible by selecting the icon on the screen with the aid of a cursor and by pressing a button, they are also accessible through keys of the keyboard 2.4.

According to a refinement, the degraded video content is transmitted to the dubbing studio with reading attributes intended for the dubber. Typically, these attributes provide the dubber with indications regarding how to read the text, for example: fast, slow, monotone, shouting, sobbing, in a shrill voice, in a deep voice, stammering, etc. The reading attributes are associated with time markers so as to appear at the moment when the text to which these attributes relate is displayed. These attributes appear in a specific window of the menu.

According to a refinement, the various windows (script, command menu, reading attributes, time bar, etc.) are displayed in a degraded part of the image so as not to impede the readability of the faces. The cursor moving with the mouse disappears when its position is situated in a face area. The detection of the degraded areas of the image is performed at the level of the dubbing studio by analyzing the image with the knowledge of the type of degradation. The nature of the degradation (blurring, scratching, hatching, lack of contrast, etc.) is transmitted as service information together with the degraded video.

According to one variant, the producer apparatus dispatches with the degraded video the spatial coordinates of the areas containing the actors' faces or lips, or areas containing the actors' faces or lips. The dubbing studio places the menu windows so as not to overlap any of the degraded areas of the image. Thus, the reproduction apparatus does not need to determine the degraded and non-degraded areas in order to position the various windows.

FIG. 6 represents another exemplary menu displayed by a dubbing studio 2.1. The displayed image comprises two actors whose speech is dubbed by two dubbers. Each dubber sees a blurred image with the exception of the two faces of the individuals. If the dubbers work together, the dubbing is performed by displaying the two scripts on the same screen. In this case, two script banners are displayed. The graphical cursor indicating the moment of reading can be situated on one or the other of the banners, or on both if the dubbers have to speak at the same time.

The present embodiments should be considered by way of illustration but may be modified within the domain defined by the scope of the appended claims. In particular, the invention is not limited to the decoders described previously but to any apparatus fitted with circuits having security constraints.

1. A method for adding a new voice content to an audiovisual document, comprising a step of receiving a video document composed of images in a reproduction device, wherein certain images of the video document received possess at least one degraded area and at least one non-degraded area, the method furthermore comprising the following steps:
during the reproduction of the video document, acquisition of at least one voice content at a moment defined by a time marker, said time marker defining a zone of the video document whose images contain visual elements appearing in at least one non-degraded area,
transmission to a manager of audiovisual documents of the at least one newly acquired voice content and of the associated time marker,
assembly of the audiovisual document and of at least one newly acquired sound content in such a way that the voice content is reproduced at the moment defined by the associated time marker.

2. The method for adding a new voice content as claimed in claim 1; wherein it comprises a step of transmitting a text representing the speech of the new voice content and of a plurality of time markers associated with the text, and a step of display by the reproduction apparatus of at least one part of said text at the moment indicated by said time markers during the reproduction of the video document.

3. The method for adding a new voice content as claimed in claim 2; wherein it comprises a step of transmitting a list of attributes associated with the text transmitted and of a plurality of time markers associated with the attributes, and a step of display by the reproduction apparatus of said attributes at the moment indicated by said time markers during the reproduction of the video content.

4. The method for adding a new voice content as claimed in claim 2; wherein the text is displayed in at least one graphical window placed by the reproduction device in a degraded area of the images of the video document.

5. The method for adding a new voice content as claimed in claim 4; wherein the reproduction device employs a means for detecting the degraded areas of the images of the video document so as to position therein the graphical window displaying the text.

6. The method for adding a new voice content as claimed in claim 4; wherein it comprises a step of reception by the reproduction device of the position of the degraded areas of the video document so as to position therein the graphical window displaying the text.

7. The method for adding a new voice content as claimed in claim 1, wherein it comprises a step of transmitting an audio content constituting the original sound track of the audiovisual document and a step of reproducing said audio content during the reproduction of the video content.

8. A viewing device comprising a means for receiving a video document arising from the audiovisual document, a means of acquisition and recording of voice contents; wherein certain images of the video document received possess at least one degraded area and at least one non-degraded area, the acquisition device effecting the acquisition of at least one voice content at a moment defined by a time marker, said time marker defining a zone of the video document whose images contain visual elements displayed by a display means during the reproduction of the video document, the visual elements appearing in at least one non-degraded area, a means for transmitting at least one newly acquired voice content and the associated time marker.

9. The viewing device as claimed in claim 8; wherein the reception means receives a text containing the speech of the new voice content and a plurality of time markers associated with said text, the display means displaying at least one part of said text during the reproduction of the video document at a moment indicated by said time markers received.

10. The viewing device as claimed in claim 9; wherein the reception means receives a list of attributes associated with the text received and a plurality of time markers associated with said text, the display means displaying at least one attribute received during the reproduction of the video document at a moment indicated by said time markers received.

11. The viewing device as claimed in claim 9; wherein the display means displays the text in at least one graphical window placed in a degraded area of the images of the video document.

12. The viewing device as claimed in claim 11; wherein it furthermore comprises a means for detecting the degraded areas of the images of the video document so as to position therein the graphical window displaying the text.

13. The viewing device as claimed in claim 11; wherein the reception means receives the position of the degraded areas of the video document so as to position therein the graphical window displaying the text.

14. The viewing device as claimed in claim 8, wherein the reception means receives an audio content constituting the original sound track of the audiovisual document, the viewing device also comprising a means for reproducing said audio content during the reproduction of the video document.
